(19) United States
(12) Patent Application Publication
(10) Pub. No.: US 2016/0138638 A1
(43) Pub. Date: May 19, 2016

(54) SCREW ASSEMBLY WITH A STEEP THREAD

(71) Applicant: Maxon Motor AG, Sachseln (CH)

(72) Inventors: Darko LUKIC, Freiburg (DE); Olaf KLEIN, Emmendingen (DE)

(73) Assignee: MAXON MOTOR AG, Sachseln (CH)

(21) Appl. No.: 14/939,502

(22) Filed: Nov. 12, 2015

(30) Foreign Application Priority Data
Nov. 14, 2014 (EP) 14 003 851.4

(51) Int. Cl. F16B 33/06; F16B 33/02

(52) U.S. Cl. CPC F16B 33/06; F16B 33/02

(57) ABSTRACT

The present invention relates to a screw assembly with a threaded spindle and a spindle nut. The spindle nut comprises at least one threaded portion made of sintered material with an internal thread. The internal thread engages in an external thread of the threaded spindle. It is according to the invention provided that the internal thread and the external thread are configured as steep threads.

The present invention relates to a screw assembly according to the preamble of independent claim 1. A generic screw assembly comprises a threaded spindle and a spindle nut. The spindle nut comprises at least one threaded portion with an internal thread. The internal thread of the spindle nut is designed as a steep thread and engages in an external thread of the threaded spindle. Either the screw assembly or the spindle nut of the screw assembly can be rotationally driven, so that the respective other component thereby experiences an axial movement.

The threaded spindle can in conventional screw assemblies be made, for example, of ceramic, whereas the spindle nut is made of steel. Screw assemblies are also known that have a threaded spindle made of steel and a spindle nut made of bronze. In both cases, appropriate lubricant is generally used to improve the tribological properties of the screw assembly. High relative speeds between the screw assembly and the spindle nut can cause degradation of the lubricant due to coking. The lubricant must be replaced periodically to prevent that this causes friction and wear to increase. Depending on the field of use of the screw assembly, however, this is possible only with considerable effort or not at all.

A screw assembly is known from DE 10028968 A1 in which the threaded portion of the spindle nut is provided with a glide coating. The glide coating can be tissue made of a polytetrafluoroethylene. Alternatively, the glide coating can also be a coating made of sintered bronze which is filled with polytetrafluoroethylene.

Another screw assembly is known from DE 3146804 A1. In this screw assembly, the spindle nut is made of sintered material, whereas the threaded spindle is fabricated from a steel ribbon. In order to obtain the lowest possible “self-friction” and to enable direct drive by an electric motor without any intermediate gearing, the threads of the threaded spindle and the threaded nut have a minimum pitch angle. Above-mentioned coking or degradation of the lubricant can occur due to the large rotational speeds of the rotary drive and due to the resulting high relative speeds between the threaded spindle and spindle, especially at high adjustment speeds of the screw assembly. Moreover, production of the spindle nut is relatively complex and therefore expensive.

A generic screw assembly is known from DE 19831940 A1. The internal thread of the spindle nut is coated with a lubricious plastic layer. Polytetrafluoroethylene, a plastic alloy based on polytetrafluoroethylene, polyoxymethylene and polyamide are described as suitable materials for the plastic layer. The plastic layer can either be applied by injection molding or can as an intrinsically rigid insert be screwed and suitably attached to the thread of the spindle nut. The internal thread of the spindle nut can also be configured as a steep thread. Production of the spindle nut is relatively complex. A high load upon the screw assembly is limited due to the plastic layer used.

One object of the present invention is to further develop the generic screw assembly such that the screw assembly can be highly loaded and then requires particular little maintenance. Furthermore, the screw assembly is to be simple and inexpensive to produce.

The object is satisfied by the features of independent claim 1. According thereto, a solution according to the invention for a generic screw assembly is then given where the threaded portion is made of material that has an open-pore structure and is adapted to receive glide fluid. The open-pore structure of the spindle nut material is able to absorb glide fluid used for lubrication of the screw assembly and to continuously deliver it during operation, so that a sufficient lubricating film is always ensured between the threaded spindle and the spindle nut. The screw assembly thereby requires little maintenance and has a significantly longer service life. Due to the steep thread, the relative speed between the screw assembly and the spindle nut is relatively low even with rapid advance rates of the screw assembly, so that there is less risk of decomposition or coking of the lubricant used.

It is to be pointed out that a threaded portion within the meaning of the present application is to be understood as being no glide coating of an inner thread as is known from the above-mentioned prior art, but a solid body with a through-hole and internal threads. It is further to be pointed out that a steep thread within the meaning of the present application is understood as being a thread which has a larger pitch angle than a regular thread.

Advantageous embodiments of the present invention are the subject matter of the dependent claims.

In one preferred embodiment of the present invention, the steep thread has a pitch angle of at least 6 degrees. The relative speed between the threaded spindle and the spindle nut is thereby even at high advance rates of the screw assembly reduced to values that prevent decomposition or coking of the lubricant used. This increases, firstly, the maintenance interval of the screw assembly according to the invention and, secondly, its service life. Manufacture is also simplified, in particular in an embodiment in which the entire spindle nut is fabricated in one piece.

In a further particularly preferred embodiment of the present invention, the material for the threaded portion is soaked with glide fluid. Sufficient lubrication between the threaded spindle and the spindle nut is thereby ensured without additional lubricant. The screw assembly is immediately ready for use.

Synthetic hydrocarbon oil is particular preferably suited as a glide fluid. Alternatively, mesogenic (liquid-crystal-based) liquids or fluid mixtures containing mesogenic (liquid-crystal-based) fluids can be used as a glide fluid. Soaking the threaded portion with the glide fluid is preferably performed in a vacuum.

In a further embodiment of the present invention, the material is sintered material. Sintered materials can be produced particularly easily to have an open-pore structure. The configuration of the internal thread as a steep thread has the advantage that a threaded portion with the steep thread can be produced much easier by use of a sintering method than a threaded portion with a fine or a regular thread.

In a further preferred embodiment of the present invention, the sintered material of the threaded portion is sintered metal, in particular metal foam produced by use of a sintering process. Alternatively, metal foam produced in a melt metallurgy process can be used. Particularly advantageous friction pairing is achieved when using a threaded spindle made of ceramic. Sintered metal is also particularly easily soaked with a glide fluid and ensures an overall high service life of the screw assembly according to the invention. To prevent that the pores of the sintered metal clog over time so that proper buildup of a lubricating film between the threaded spindle and the spindle nut could be impaired with advancing age of the screw assembly, corrosion-resistant sintered steel or sintered bronze can particularly preferably be used as sintered metal.

It has proven advantageous if the material has a density of 6.4 g/cm³ to 6.8 g/cm³. This applies especially for the sintered steel mentioned.

In order to ensure proper lubrication and at the same time the greatest possible stability and load capacity, the material in a further particularly preferred embodiment of the present invention has a pore volume of 15+/−2.5%.

In a further preferred embodiment of the present invention, the sintered material is produced using coarse-grained granulate. Particularly simple and inexpensive production with homogeneously distributed pores is thereby possible.

More preferably, the open-pore structure is created by powder injection molding of metal or ceramic. Placeholder material can also be used instead of using courses granulate. Alternatively, the open-pore structure can also be created from metal foam, ceramic foam or a hollow sphere structure. It is also possible to perform production by use of selective laser sintering, selective laser melting or electron beam melting.

In a further preferred embodiment of the present invention, the threaded portion is at least in the region of the thread engagement surfaces hardened and/or surface treated and/or coated. This further increases the service life of the screw assembly according to the invention.

In a particularly preferred embodiment of the present invention, the spindle nut comprises two threaded portions each configured as a threaded bushing and arranged coaxial to each other. It is thereby possible to produce relatively long spindle nuts using standardized short threaded bushings that are relatively easy to manufacture. The shorter the threaded bushings, the easier the sintering process and in particular the shaping of the threaded bushing can be effected. The two threaded bushings are preferably held axially spaced from each other so that an additional amount of glide fluid can if needed be received between the threaded bushings. The two threaded bushings are preferably held in a common housing of the spindle nut or are firmly connected to the common housing, respectively. The housing can be, for example, a hollow-cylindrical sleeve. The two threaded bushings can inter alia be soldered to the hollow-cylindrical sleeve, or otherwise attached to the sleeve. In order to simplify the manufacture of the spindle nut, the common housing can be provided with a stepped bore, so that a respective axial stop is formed for the two threaded bushings. To receive a sufficient amount of glide fluid, the wall thickness of the threaded bushings is further preferably at least twice the thread depth of the internal thread. Particularly preferably, the wall thickness is at least three times the thread depth. These advantageous embodiments moreover lend themselves very generally to the threaded portion or the threaded portions, regardless of whether the threaded portion is designed as a threaded bushing. Instead of a multi-part configuration, the spindle nut can of course also be manufactured in one piece, for example, in the sintering process.

In a further preferred embodiment of the present invention, the threaded spindle of the screw assembly is fabricated from ceramic. When using a spindle nut made of sintered steel, this results in particularly advantageous and stable friction pairing. The service life of the screw assembly according to the invention is by the use of a threaded spindle made of ceramic further increased. Zirconia is preferably suited as ceramic material. The threaded spindle very particularly preferably exhibits a smooth polished surface at least in the region of the thread engagement surfaces. This also contributes to increased service life and flawless operation of the screw assembly according to the invention.

In a further preferred embodiment of the present invention, the threaded spindle has a diameter in the range of 1 mm to 12 mm.

In a further preferred embodiment, the screw assembly according to the invention comprises an electric motor with a multi-stage planetary gearing as a drive. Alternatively, either the threaded spindle or the spindle nut can be driven. Of course, any other reduced gearing can be used instead of a multi-stage planetary gearing. Multi-stage reduction gearings are preferably to be used, so that relatively small-sized electric motors can be employed.

The invention further provides a spindle nut for the screw assembly according to the invention.

The invention is illustrated in more detail below by use of drawings, where

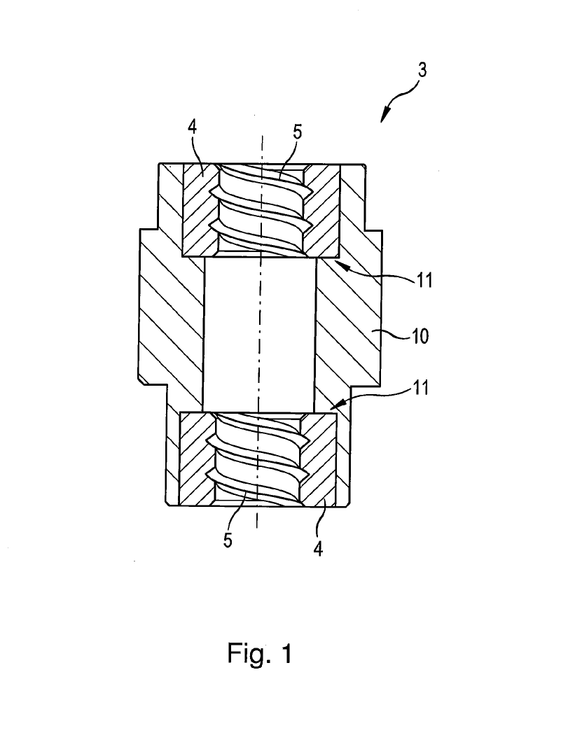

FIG. 1: shows a longitudinal sectional view of a spindle nut according to the invention,

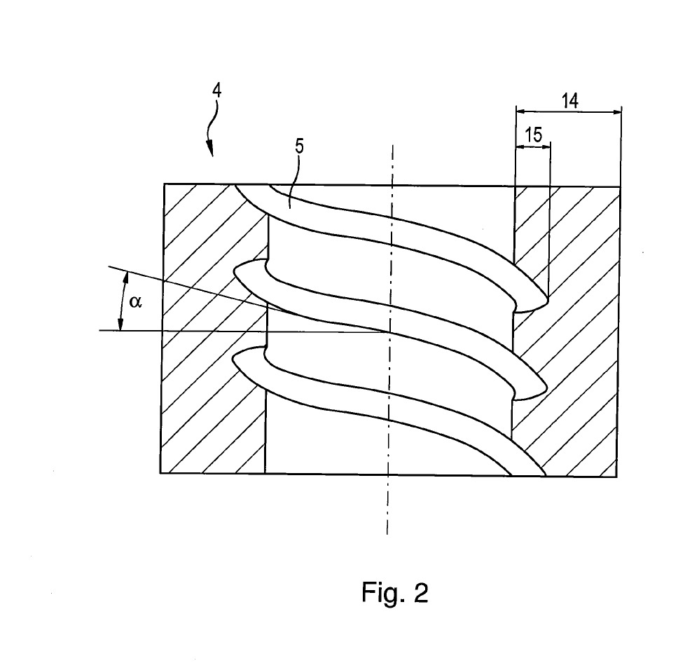

FIG. 2: shows a detailed view of one of the two threaded bushings of the spindle nut shown in FIG. 1,

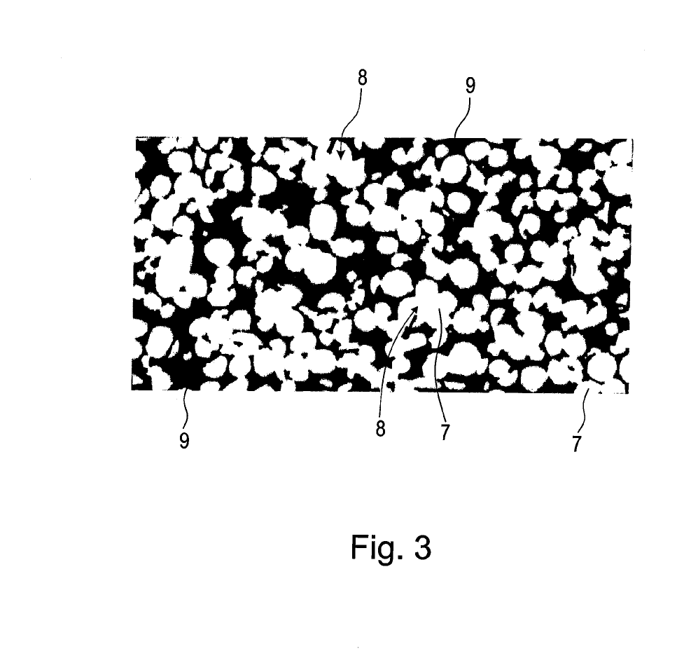

FIG. 3: shows a sectional enlargement of the sintered material of the threaded bushing shown in FIG. 2, and

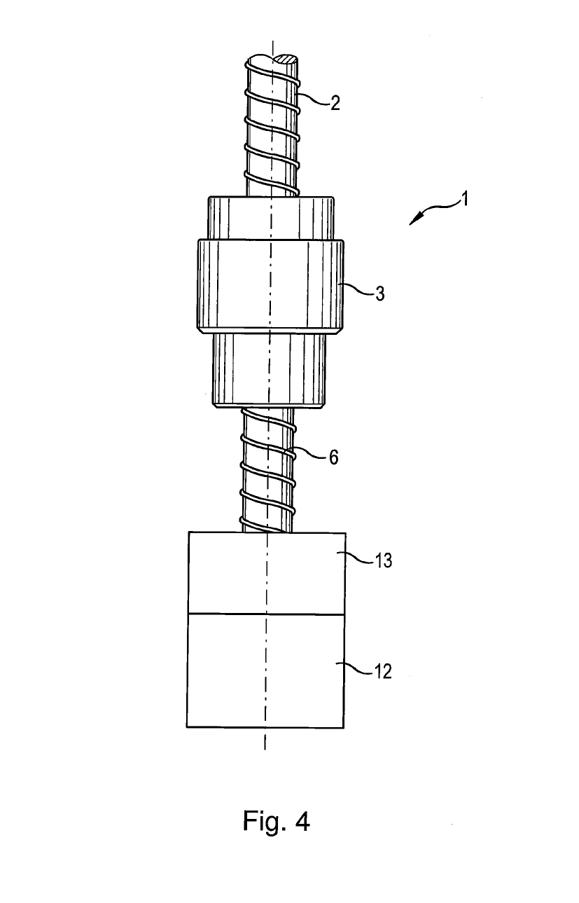

FIG. 4: shows a screw assembly according to the invention with the spindle nut shown in FIG. 1.

It applies to the following embodiments that like components are designated with like reference numerals. If a drawing contains reference numerals which are not explained in more detail in the accompanying figure description, then reference is made to preceding or subsequent figure descriptions.

FIG. 1 shows a spindle nut 3 according to the invention in a longitudinal sectional view. Spindle nut 3 has a multipart configuration and comprises a housing 10 and two threaded bushings 4 inserted into the housing. The two threaded bushings 4 are made of sintered steel and are arranged coaxial to each other in housing 10. The two threaded bushings are also axially spaced apart form each other. In order to position the two threaded bushings exactly in housing 10, the housing is configured as a hollow-cylindrical sleeve having a central stepped bore. The stepped bore comprises two steps 11 formed as axial stops up to which the two threaded bushings 4 each can be inserted from the lower and the upper end, respectively, of housing 10 into the central bore. Just like the two threaded bushings 4, housing 10 can be made of corrosion-resistant steel. In contrast to the two threaded bushings, however, it is not necessary that the housing be produced from sintered material. The housing and the threaded bushings are suitably connected to each other. For example, threaded bushings 4 can be soldered to housing 10.

FIG. 2 shows a detailed view of one of the two threaded bushings 4 shown in FIG. 1. It can be seen clearly that internal thread 5 of threaded bushing 4 is configured as a steep thread. The pitch angle a of the steep thread is approx. 15°. It can also be seen in the illustration that threaded bushing 4 is embodied as a solid component. Wall thickness 14 of the threaded bushing is more than three times the thread depth 15 of the steep thread.

FIG. 3 shows an enlarged view of the material of which threaded bushing 4 is made. The material is corrosion-resistant sintered steel with an open-pore structure. This means that pores 8 are formed between steel skeleton 9 and make up roughly 15% of the total volume. The sintered steel thereby has a density of about 6.6 g/cm³. The pores 8 of the sintered material are created by the use of coarse-grained granulate. In order to ensure inexpensive and reliable lubrication, the two threaded bushings 4 of the spindle nut are soaked with a glide fluid, namely synthetic hydrocarbon oil. To fill the open-pore structure as completely as possible with the glide fluid, the soaking process preferably occurs in a vacuum. The glide fluid is thereby received in pores 8 of the sintered material and creates a respective lubrication film due to the capillary action to the engagement surfaces of the thread.

FIG. 4 finally shows a screw assembly 1 according to the invention with spindle nut 3 shown in FIG. 1. Screw assembly 1 in addition to spindle nut 3 comprises a threaded spindle 2 whose external thread 6 interacts with internal thread 5 of the spindle nut. Threaded spindle 2 is made of ceramic, preferably of zirconium oxide. To reduce wear, the threaded spindle has a smooth polish at least in the region of thread engagement surfaces. The threaded spindle is driven by an electric motor 12 with a multi-stage reduced planetary gearing 13. In the screw assembly according to the invention, a relatively large advance rate of spindle nut 3 is created in the axial direction by a relatively moderate rotational speed of threaded spindle 2. Spindle nut 3 is for this purpose of course guided axially displaceably but in a rotationally fixed manner by guides - not shown. Unlike in the illustration, it is of course also possible to drive spindle nut 3 with the electric motor instead of driving threaded spindle 2.

1. Screw assembly with a threaded spindle and a spindle nut, where said spindle nut comprises at least one threaded portion with an internal thread, and where said internal thread is configured as a steep thread and engages in an external thread of said threaded spindle, wherein said threaded portion is made of material that has an open-pore structure and is adapted to receive a glide fluid.

2. Screw assembly according to claim 1, wherein said steep thread has a pitch angle a of at least 10°.

3. Screw assembly according to claim 1, wherein said material is soaked with a glide fluid.

4. Screw assembly according to claim 3, wherein said glide fluid is synthetic hydrocarbon oil, a mesogenic (liquid-crystal-based) liquid or a fluid mixture containing a mesogenic (liquid-crystal-based) fluid.

5. Screw assembly (1) according to claim 1, wherein said material is sintered material.

6. Screw assembly according to claim 5, wherein said sintered material is corrosion-resistant sintered steel or sintered bronze.

7. Screw assembly according to claim 1, wherein said material has a density of 6.4 g/cm³ to 6.8 g/cm³.

8. Screw assembly (1) according to claim 1, wherein said material has a pore volume of 15+/−2.5%.

9. Screw assembly according to claim 5, wherein said sintered material is produced using coarse-grained granulate.

10. Screw assembly according to claim 1, wherein said threaded portion is hardened and/or surface treated and/or coated.

11. Screw assembly according to claim 1, wherein said spindle nut comprises two threaded portions each configured as a threaded bushing and arranged coaxial to each other.

12. Screw assembly according to claim 1, wherein said threaded spindle is fabricated from ceramic.

13. Screw assembly according to claim 1, wherein said threaded spindle has a diameter in the range between 1 mm and 12 mm.

14. Screw assembly according to claim 1, wherein said screw assembly comprises an electric motor with a multi-stage planetary gearing as a drive.

15. Spindle nut for a screw assembly, comprising the features of claim 1.
